(19) United States
(12) Patent Application Publication
(10) Pub. No.: US 2024/0323474 A1
(43) Pub. Date: Sep. 26, 2024

(54) UNIVERSAL REMOTE CONTROL WITH TOUCH KEYBOARD AND TOUCH MOUSE FUNCTIONS

(71) Applicant: Bitel Co., Ltd., Seongnam-si (KR)

(72) Inventor: Hoon Sung Jung, Seoul (KR)

(21) Appl. No.: 18/605,156

(22) Filed: Mar. 14, 2024

(30) Foreign Application Priority Data
Mar. 23, 2023 (KR) 10-2023-0038181

(51) Int. Cl. H04N 21/422

(52) U.S. Cl. CPC H04N 21/42224; H04N 21/42208; H04N 21/42221

(57) ABSTRACT

A universal remote control with touch keyboard and touch mouse functions provides convenient control of home entertainment and smart home devices by implementing touch keyboard and touch mouse functions in a single remote control. The universal remote control includes a touchpad for receiving information through touch, a display unit coupled to the touchpad and displaying information, a keyboard unit for selecting functions and entering information, a central processing unit (CPU), which controls information display of the display unit, calculates and processes coordinate values inputted through the touchpad to generate coordinate data of a device to be controlled, converts the coordinate data into mouse cursor display data of the device to be controlled, and controls wireless transmission of the mouse cursor display data, an infrared unit transmits an infrared signal under control of the CPU, and a Bluetooth unit transmits a Bluetooth signal wirelessly under control of the CPU.

### TECHNICAL FIELD

The present invention relates to a universal remote control with touch keyboard and touch mouse functions and, more particularly, to a universal remote control with touch keyboard and touch mouse functions which can improve user convenience through convenient control of home entertainment and smart home devices by implementing touch keyboard and touch mouse functions in a single remote control.

### BACKGROUND ART

In general, remote controls are used for various smart devices such as televisions, digital versatile disc DVD players, video cassette recorders VCRs, cable broadcasting devices, set-top boxes, audio systems, amplifiers AMPs, air conditioners, fans, air purifiers, smartphones, TAPs, and laptop PCs.

Each remote control provided separately for each electronic device uses infrared IR, Bluetooth, and Wi-Fi as communication methods.

When transmitting infrared and wireless signals, the remote controls transmit infrared and wireless signals according to control codes specified differently for each manufacturer's electronic devices in order to distinguish between electronic devices from a certain manufacturer and electronic devices from other manufacturers.

However, when different types of electronic devices are used at home, a corresponding number of remote controls are used, which causes difficulties in managing several remote controls. In addition, when a user wants to select and use a new one of the electronic devices, he or she has to replace the remote control each time, which causes inconvenience.

In order to solve the problems, a universal remote control that can control several electronic devices has recently been commercialized.

With the introduction of such a universal remote control, it has become possible to control a variety of electronic devices with a single remote control, rather than having to control each electronic device with a separate remote control.

However, even when using such a single universal remote control that comprehensively controls various electronic devices as described above, the remote control has the disadvantage of being complicated to use. In addition, in order to select the position of an operation button on the screen of an electronic device, the position is selected based on a trackball or multi-axis sensor, wherein it costs a lot to design a remote control with a built-in trackball or multi-axis sensor, and it is inconvenient to operate the remote control. Herein, such a method of selecting a position based on the multi-axis sensor has difficulties in inputting text and selecting icons based on the position selection on the screen.

Meanwhile, as the Internet has recently become popular and the information age has arrived, the Internet has become an essential element in our lives. As a result, there have been continuous attempts to incorporate the Internet into real life, and the Internet has already been incorporated and established in various fields such as finance, education, and commerce. And now, moving away from the concept of accessing the Internet through personal computers, digital information appliances that combine existing home appliances with the Internet have been released.

A digital broadcasting receiver (set top box) is one of these digital information appliances, enabling interactive services by supporting the function of receiving digital broadcasting signals as well as functions such as information search, shopping, and broadcast program downloading through the Internet.

In order to access the Internet through a digital broadcasting receiver and implement interactive services such as information search and shopping, the process of receiving text from a user is essential. In this case, the user has to look at key buttons and a display unit alternately while entering text, which results in the disadvantage that it takes a lot of time to input text.

Therefore, in order to solve the problems with the remote control, patent document 1 below discloses a remote control technology that allows easy text input.

The prior art disclosed in patent Document 1 includes a first step in which, when a virtual key included in a virtual keyboard is selected by a cursor operation unit provided on a remote control, a first signal assigned to the selected virtual key is input, a second step in which, when a key button provided on the remote control is selected, a second signal assigned to the selected key button is input, and a third step in which a control unit completes text by combining the first signal and the second signal and outputs the text to a display unit. Through this configuration, it is possible to input all types of characters even if the number of key buttons to be provided on the remote control is reduced, thereby simplifying and miniaturizing the remote control. In addition, a user can input text more quickly by using a touchpad and key buttons provided on the remote control in parallel.

However, this prior art adopts a method of displaying the virtual keyboard on a display device of a relevant electronic device and transmitting text to the electronic device through interaction between the display device and the remote control, and thus has disadvantages in that it is inconvenient to implement the virtual keyboard and it is not possible to implement a wireless mouse function using the remote control.

### PRIOR ART DOCUMENT

### Patent Document

(Patent Document 1) Korean Reg. Patent No. 10-2,123,306 (Reg. on 10 Jun. 2020) (Method and apparatus for text input using remote controller)

### DISCLOSURE OF THE INVENTION

### Technical Problem

Therefore, the present invention is proposed to solve the inconvenience caused by the use of individual remote controls for each general electronic device as described above, the inconvenience caused by the use of universal remote controls, and the disadvantages of remote controls capable of text input mentioned in the prior art, and the purpose of the present invention is to provide a universal remote control with touch keyboard and touch mouse functions, which can improve user convenience through convenient control of home entertainment and smart home devices by implementing touch keyboard and touch mouse functions in a single remote control.

### Technical Solutions

In order to achieve the above-mentioned purpose, a universal remote control with touch keyboard and touch mouse functions according to the present invention includes a touchpad for receiving information through touch, a display unit coupled to the touchpad and displaying information, a keyboard unit for selecting functions and entering information, a central processing unit, which controls information display of the display unit, calculates and processes coordinate values inputted through the touchpad so as to generate coordinate data of a device to be controlled, converts the coordinate data into mouse cursor display data of the device to be controlled, and controls wireless transmission of the mouse cursor display data, an infrared unit, which converts the mouse cursor display data of the device to be controlled into an infrared signal and transmits the infrared signal under control of the central processing unit, and a Bluetooth unit, which converts the mouse cursor display data of the device to be controlled into a Bluetooth signal and transmits the Bluetooth signal wirelessly under control of the central processing unit.

The central processing unit implements mouse mode display on the display unit, acquires and processes touch coordinate values in response to occurrence of a touch through the touchpad so that coordinate data for displaying a mouse cursor is generated and the mouse cursor is displayed on the device to be controlled.

The central processing unit displays a mouse cursor on the device to be controlled and implements function selection or data input functions through the touchpad and/or the keyboard unit.

The universal remote control described above implements mouse function by using the touchpad and the display unit, thereby allowing intuitive selection of the position of the device to be controlled.

Furthermore, the universal remote control with touch keyboard and touch mouse functions according to the present invention includes a battery unit, which supplies driving power by charging power and discharging the charged power, and a power unit, which appropriately converts the power discharged from the battery unit into power to be used in the universal remote control so as to supply driving power, wherein the battery unit is provided with a wireless charging means so as to receive charging power wirelessly.

### Advantageous Effects of the Invention

According to the present invention, touch keyboard and touch mouse functions are implemented in a single remote control so that home entertainment and smart home devices can be conveniently controlled, thereby improving user convenience.

Additionally, according to the present invention, various communication methods as well as TFT touch function and mouse function are implemented in one universal remote control, so that it is possible to achieve integrated operation of various smart devices such as televisions, digital versatile disc DVD players, video cassette recorders VCRs, cable broadcasting devices, set top boxes, audio systems, amplifiers AMPs, air conditioners, fans, air purifiers, smartphones, TAPS, and laptop PCs.

### BRIEF DESCRIPTION OF DRAWINGS

FIG. 1 is a block diagram of a universal remote control with touch keyboard and touch mouse functions according to the present invention, and

FIG. 2 is a flowchart showing the operation of the universal remote control with touch keyboard and touch mouse functions according to the present invention.

### MODE FOR INVENTION

Hereinafter, a universal remote control with touch keyboard and touch mouse functions according to preferred embodiments of the present invention will be described in detail with reference to the accompanying drawings.

It should be noted that terms or words used in the present invention described below should not be construed as limited to their usual or dictionary meanings but should be interpreted as meanings and concepts consistent with the technical idea of the present invention based on the principle that the present inventor can appropriately define the concept of terms to explain his invention in the best way.

Therefore, the embodiments described herein and the configurations shown in the drawings are only preferred embodiments of the present invention and do not represent the entire technical idea of the present invention. It should be understood that there may be various equivalents and modifications that can replace them at the time of filing this application.

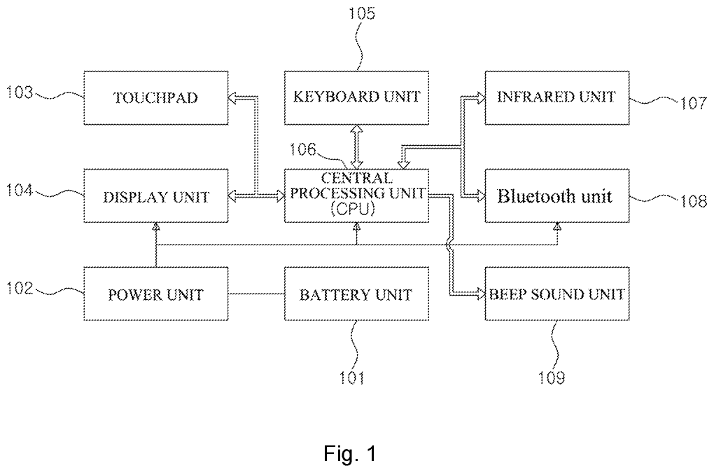

FIG. 1 is a block diagram of a universal remote control 100 with touch keyboard and touch mouse functions according to the present invention (hereinafter, referred to as “universal remote control”), which may include a battery unit 101, a power unit 102, a touchpad 103, a display unit 104, a keyboard unit 105, a central processing unit CPU 106, an infrared unit 107, a Bluetooth unit 108 and a beep sound unit 109.

The battery unit 101 serves to charge power and discharge the charged power so as to supply driving power. The battery unit 101 may include a rechargeable secondary battery and be equipped with a wireless charging means to receive charging power wirelessly. Lithium-ion batteries can be used. This battery unit 101 may include a wired charging terminal (USB Type C) that can be charged by wire.

The power unit 102 serves to properly convert the power discharged from the battery unit 101 into power to be used by the universal remote control 100 so as to supply driving power.

This power unit 102 may be provided with a DC/DC converter.

The touchpad 103 serves to receive information through touch. To this end, a plurality of coordinates are set on the touchpad 103, so that when a touch occurs, coordinate values of a corresponding touch position can be outputted. Various types of touchpads may be used as the touchpad 103.

The display unit 104 is coupled to the touchpad 103 and serves to display information. This display unit 104 can be implemented as a color display. The touchpad 103 and the display unit 104 are combined to implement one TFT touch color display.

Herein, the touchpad 103 and the display unit 104 implement a touch mouse function so as to intuitively display a cursor on a device to be controlled, thereby enabling easy selection of a position on the device to be controlled and improving convenience of operation for a user.

The keyboard unit 105 serves for function selection and information input. This keyboard unit 105, unlike a normal keyboard for inputting information such as letters and numbers, can be implemented to enable function selection and information input by using only a few buttons such as a menu input button, a guide button, volume up/down buttons, channel up/down buttons, a home button, a play button, and a double speed playback button.

The central processing unit CPU 106 serve to control information display of the display unit 104, calculate and process coordinate values inputted through the touchpad 103 so as to generate coordinate data of the device to be controlled, and convert the generated coordinate data into mouse cursor display data of the device to be controlled so as to transmit the mouse cursor display data wirelessly.

This central processing unit 106 can learn infrared control function of a device to be controlled based on programs for controlling home entertainment devices and smart home devices, downloaded through the Bluetooth unit 108.

In addition, the central processing unit 106 can implement a mouse mode display on the display unit 104. Furthermore, when a touch occurs through the touchpad 103, the central processing unit 106 can obtain and process touch coordinate values so as to generate coordinate data for displaying a mouse cursor so that a mouse cursor can be displayed on the device to be controlled.

Additionally, the central processing unit 106 can display a mouse cursor on the device to be controlled, thereby implementing function selection or data input functions through the touchpad 103 and/or the keyboard unit 105.

In response to the control of the central processing unit 106, the infrared IR unit 107 serves to convert the mouse cursor display data of the device to be controlled into an infrared signal and transmit the infrared signal to the device to be controlled.

In response to the control of the central processing unit 106, the Bluetooth unit 108 serves to convert the mouse cursor display data of the device to be controlled into a Bluetooth signal and transmit the Bluetooth signal wirelessly to the device to be controlled.

This Bluetooth unit 108 can carry out two-way communication with the device to be controlled through Bluetooth communication, and download programs for controlling home entertainment devices and smart home devices through various smart devices such as PCs, laptop computers, TAPs, smartphones, DVD players, and TVs.

The beep sound unit 109 may serve to inform a user of an operation status by transmitting a beep sound in response to an operation signal during function selection and data input under the control of the central processing unit 106.

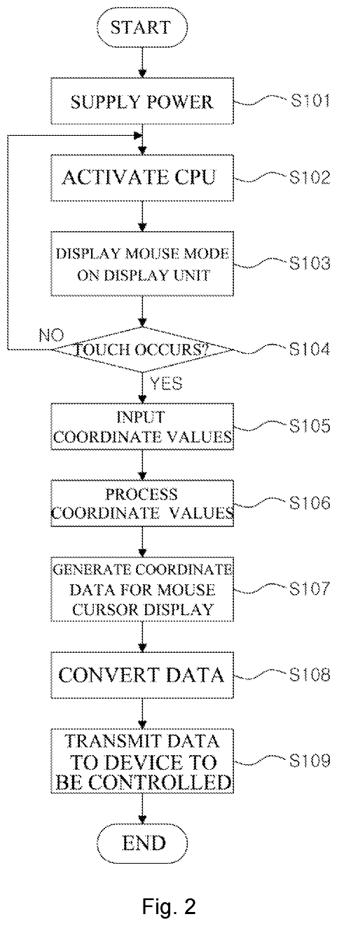

Hereinafter, operations of the universal remote control 100 with touch keyboard and touch mouse functions according to a preferred embodiment of the present invention configured as described above will be explained in detail with reference to FIG. 2.

First, the battery unit 101 supplies driving power by discharging the power charged in the battery unit 101. Herein, the battery unit 101 can charge a built-in battery by wirelessly receiving power transmitted from a wireless charger by using the wireless charging means, or charge the built-in battery by receiving charging power supplied by wire through a USB terminal.

The power unit 102 uses a DC/DC converter to convert direct current power supplied from the battery unit 101 into the direct current power required by each unit of the universal remote control 100 and supplies the converted direct current power to a corresponding unit (S101).

When power is supplied, the central processing unit 106 is activated and implements mouse mode display on the display unit 104 (S102-S103).

In the state, where the mouse mode is displayed on the display unit 104, a user selects a device to be controlled by operating the menu selection button or a certain device selection button on the keyboard unit 105.

In the state, where a device to be controlled is selected, the user touches a certain position through the touchpad 103 so as to control the device to be controlled (S104).

When a certain position is touched through the touchpad 103, the touchpad 103 transmits coordinate values corresponding to the touched position to the central processing unit 106 (S105).

Herein, a screen displayed on display unit 104 can be said to correspond to a screen of an actual device to be controlled. In other words, a top left portion of the screen of the display unit 104 can correspond to a top left portion of the screen of the device to be controlled, a bottom left portion of the screen of the display unit 104 can correspond to a bottom left portion of the screen of the device to be controlled, an upper right portion of the screen of the display unit 104 can correspond to an upper right portion of the screen of the device to be controlled, and a bottom right portion of the screen of the display unit 104 can correspond to a bottom right portion of the screen of the device to be controlled.

Since the screen of the display unit 104 has coordinates set in units of certain cells, when a user touches a certain position, coordinate values for that position are generated and transmitted to the central processing unit 106.

The central processing unit 106 calculates the input coordinate values of the position and generates coordinate data for displaying a mouse cursor based on the calculation result (S107). Herein, the coordinate data for displaying a mouse cursor means the touch position of the display unit 104, which can be said to correspond to the screen position of the device to be controlled.

The central processing unit 106 generates the coordinate data for displaying a mouse cursor and then transmits the coordinate data for displaying a mouse cursor through a communication unit for controlling the device to be controlled, that is, the infrared unit 107 or the Bluetooth unit 108. Herein, since the device to be controlled is selected in advance and a control method for the device to be controlled is set in advance, by selecting the communication unit corresponding to device to be controlled, the coordinate data for mouse cursor display can be optimally transmitted to device to be controlled (S108-S109).

For example, when the device to be controlled transmits and receives data through infrared communication, the coordinate data for mouse cursor display is transmitted to the infrared unit 107, and the infrared unit 107 converts the received coordinate data for mouse cursor display into an infrared signal corresponding to the device to be controlled and transmits the infrared signal to the device to be controlled.

In addition, when the device to be controlled transmits and receives data through Bluetooth communication, the coordinate data for mouse cursor display is transmitted to the Bluetooth unit 108, and the Bluetooth unit 108 converts the received coordinate data for mouse cursor display into Bluetooth data and wirelessly transmits the Bluetooth data to the corresponding device to be controlled. Herein, the Bluetooth unit 108 can minimize power usage by using a wireless module RF such as low-power Bluetooth.

The device to be controlled that has received the coordinate data for mouse cursor display displays a mouse cursor at a screen position corresponding to the position of the coordinate data for mouse cursor display.

Therefore, it is possible to perform wireless mouse function by using the universal remote control 100 and readily select a screen position of a control target.

Existing remote controls with an air mouse function use multi-axis sensors or trackballs, so have disadvantages in that it costs a lot to build expensive multi-axis sensors into the remote controls, and operation for selecting a position is inconvenient when using the multi-axis sensors.

In contrast, the present invention can simply implement a wireless touch mouse function by using a TFT touch LCD without having a built-in multi-axis sensor, so it is possible to intuitively select a position on a screen and at the same time make position selection accurate and convenient.

With the mouse cursor displayed on the screen of the device to be controlled, if selection of a certain function or data input is performed through the touchpad 103 or the keyboard unit 105, the central processing unit 106 processes the selection of a certain function or data input and then transmits the function selection or data input through the infrared unit 107 or the Bluetooth unit 108 according to the communication of the device to be controlled. As a result, the universal remote control 100 may replace a wireless keyboard.

Since a user can use the universal remote control 100 to perform the wireless mouse and wireless keyboard functions as described above, text input, icon selection or the like can be performed simply and conveniently.

Meanwhile, as another feature of the present invention, the central processing unit 106 can learn the infrared control function of the device to be controlled based on the programs for controlling home entertainment devices and smart home devices, downloaded through the Bluetooth unit 108.

Herein, since infrared control data may be different for each device to be controlled, learning the infrared control function means that, through learning, input data can be converted into data suitable for the device to be controlled so that an infrared signal suitable for the device to be controlled can be transmitted.

According to the present invention described above, it is possible to conveniently control home entertainment devices and smart home devices by implementing touch keyboard and mouse functions in a single remote control, thereby improving user convenience.

In addition, according to the present invention, various communication methods as well as TFT touch function and mouse function are implemented in one universal remote control, so that it is possible to conveniently operate in an integrated manner various smart devices such as televisions, digital versatile disc DVD players, video cassette recorders VCRs, cable broadcasting devices, set top boxes, audio systems, amplifiers AMPs, air conditioners, fans, air purifiers, smartphones, TAPS, and laptop PCs.

Although the present invention created by the present inventor has been described in detail according to the above embodiments, the present invention is not limited to the embodiments, and it would be obvious to those skilled in the art that various changes can be made without departing from the gist of the invention.

### EXPLANATION OF REFERENCE SIGNS

100: Universal remote control
101: Battery unit
102: Power unit
103: Touchpad
104: Display unit
105: Keyboard unit
106: Central processing unit (CPU)
107: Infrared unit
108: Bluetooth unit
109: Beep sound unit

What is claimed is:

1. A universal remote control with touch keyboard and touch mouse functions, comprising:
a touchpad for receiving information through touch;
a display unit coupled to the touchpad and displaying information;
a keyboard unit for selecting functions and entering information;
a central processing unit, which controls information display of the display unit, calculates and processes coordinate values inputted through the touchpad so as to generate coordinate data of a device to be controlled, converts the coordinate data into mouse cursor display data of the device to be controlled, and controls wireless transmission of the mouse cursor display data;
an infrared unit, which converts the mouse cursor display data of the device to be controlled into an infrared signal and transmits the infrared signal under control of the central processing unit; and
a Bluetooth unit, which converts the mouse cursor display data of the device to be controlled into a Bluetooth signal and transmits the Bluetooth signal wirelessly under control of the central processing unit,
wherein the central processing unit implements mouse mode display on the display unit, and performs control such that touch coordinate values are acquired and processed in response to occurrence of a touch through the touchpad so that coordinate data for displaying a mouse cursor is generated and the mouse cursor is displayed on the device to be controlled, and in a state where a mouse mode is displayed on the display unit,
if a menu selection button or a certain device selection button of the keyboard unit is manipulated, the central processing unit recognizes a device to be controlled, and if a certain function is selected or data is inputted through the touchpad, or if a function is selected and data is inputted through the keyboard unit, the central processing unit wirelessly transmits the selected function or the inputted data to the device to be controlled according to communication of the device to be controlled, thereby performing wireless keyboard.

2. The universal remote control according to claim 1, wherein the Bluetooth unit downloads programs for controlling home entertainment devices and smart home devices through Bluetooth communication.

3. The universal remote control according to claim 1, wherein the central processing unit learns infrared control function of the device to be controlled on the basis of the programs for controlling home entertainment devices and smart home devices, downloaded through the Bluetooth unit.

4. The universal remote control according to claim 1, wherein the central processing unit controls mouse function by using the touchpad and the display unit, thereby allowing intuitive selection of the position of the device to be controlled.

5. The universal remote control according to claim 1, comprising:
a battery unit, which supplies driving power by charging power and discharging the charged power; and
a power unit, which appropriately converts the power discharged from the battery unit into power to be used in the universal remote control so as to supply driving power,
wherein the battery unit includes a wireless charging means to receive charging power wirelessly and/or a USB terminal to receive charging power by wire.
